(19) United States
(12) Patent Application Publication
(10) Pub. No.: US 2025/0392873 A1
(43) Pub. Date: Dec. 25, 2025

(54) Source-Dependent Audio Enhancement Processing

(71) Applicant: Sonitum Inc., Malibu, CA (US)

(72) Inventors: Lawrence Guterman, Studio City, CA (US); Dmitry Zhukov, Kotor (ME); Mikhail Rakhmalevich, Bangkok (TH); Anuj Gujar, Woodland Hiills, CA (US)

(73) Assignee: Sonitum Inc., Malibu, CA (US)

(21) Appl. No.: 18/753,796

(22) Filed: Jun. 25, 2024

(51) Int. Cl. H04R 25/00

(52) U.S. Cl. CPC H04R 25/505; H04R 2225/61

(57) ABSTRACT

System and techniques for identifying and applying personalized audio processing parameter settings for a listener with hearing loss and/or certain listening preferences. The listener creates and allows for automatic recall of a first profile representing a set of audio enhancement processing parameters associated with the listener as well as create and recall a source-dependent profile representing a further improvement, or deviation, from the first profile associated with a source signal or a category of source signals, such as the voice of a given talker.

### FIELD OF TECHNOLOGY

This patent application relates generally to hearing assists, and more specifically to hearing assist systems and techniques that improve the intelligibility or appreciation of audio signals by a person with hearing impairment and/or certain listening preferences.

### BACKGROUND

The traditional method of generating a hearing profile in the hearing aid industry includes the patient undergoing a pure tone hearing test evaluation in which the minimum audible level at which they can auditorily perceive individual frequencies is measured. This data is then sent to a hearing aid manufacturer, which applies a pre-prescribed, generalized heuristic to map the audiogram decibel levels to an output parameter value in the hearing aid signal processor. When sound enters the patient's outer ear, it is first amplified on a per-frequency basis based on the audiogram “prescription” by the hearing aid, before being relayed through the eardrum to the middle and inner ear.

While the aforementioned techniques may be used to provide assistance for a listener associated with an average talker's voice or source signal, traditional techniques only function in a personalization solution that takes into account an “average” of talkers' voices or source signals. Thus, for example, a subject with high frequency hearing loss using a sound personalization technology tuned for an average voice may have a much more difficult time understanding a young girl's voice, whose fundamental frequency and associated acoustic characteristics are quite different than an average voice of, for example, that of an “average” man.

Furthermore, implementation of such techniques have onerous regulations that limit the amount of professional audiologists that can provide even generalized hearing prescriptions. As a regulated industry, only licensed professionals may provide prescriptions for patients. This decreases availability and convenience and increases cost to an end user that requires hearing assistance.

### SUMMARY

Described herein are systems and techniques for identifying and applying personalized audio processing parameter settings for a listener with hearing loss and/or certain listening preferences.

Clause 1. A system comprising: a personalization node, comprising a personalization database and configured to establish a media session between a plurality of electronic devices, the personalization node configured to perform operations comprising: establishing a first communication session between a first electronic device; determining that the first electronic device is associated with a first user; accessing, from the personalization database and based on determining that the first electronic device is associated with the first user, a first profile associated with the first user; establishing a first media session between at least a first electronic device and a second electronic device; determining characteristics of the media provided by the second electronic device; accessing, from the personalization database and based on the characteristics of the media provided by the second electronic device, a tuning profile pertaining to the characteristics of the media; modifying first audio data provided by the second electronic device with the tuning profile pertaining to the characteristics of the media; and outputting the modified first audio data via the first electronic device.

Clause 2. The system of clause 1, wherein the first profile and the tuning profile are stored within the personalization database in a storage block associated with the first user.

Clause 3. The system of clause 1, wherein the media provided by the second electronic device is speech of a second user, and wherein the characteristics of the media is an identity of the second user.

Clause 4. The system of clause 3, wherein the first media session further includes a third electronic device, wherein the determination that the second user is speaking through the second electronic device is at a first time, and wherein operations further comprise: determining, at a second time that a third user is speaking through the third electronic device; accessing, from the personalization database and based on determining that the third user is speaking, a tuning profile pertaining to speech of the third user and associated with the first user; modifying second audio data of the third user speaking with the first profile and the tuning profile pertaining to speech of the third user; and outputting the modified second audio data through the first electronic device.

Clause 5. The system of clause 3, wherein the identity of the second user is determined by correlating identifying information provided by the second electronic device to the second user and/or by determining vocal characteristics of the speaker and correlating the vocal characteristics to the second user.

Clause 6. The system of clause 3, wherein the determination that the second user is speaking through the second electronic device is at a first time, and wherein the operations further comprise: determining, at a second time that a third user is speaking through the second electronic device; accessing, from the personalization database and based on determining that the third user is speaking, a tuning profile pertaining to speech of the third user and associated with the first user; modifying second audio data of the third user speaking with the first profile and the tuning profile pertaining to speech of the third user; and outputting the modified second audio data through the first electronic device.

Clause 7. The system of clause 1, wherein the characteristics of the media determined is a genre, title, and/or speaker of the media.

Clause 8. The system of clause 1, wherein the operations further comprise: establishing a tuning media session between at least the first electronic device and the second electronic device; determining that the media is provided during the tuning media session; outputting tuning audio data of the media through the first electronic device; receiving, from the first electronic device, tuning inputs to the tuning audio data; and storing, within the personalization database, the tuning profile pertaining to the media and associated with the first user, wherein the tuning profile is tuned by the tuning inputs.

Clause 9. The system of clause 8, wherein the tuning profile pertaining to the media and associated with the first user is accessed through a tuning profile lookup within the personalization database.

Clause 10. The system of clause 1, wherein the tuning profile pertaining to the media and associated with the first user is selected from a plurality of tuning profiles associated with the media and the first user.

Clause 11. A method comprising: establishing a first media session between at least a first electronic device and a second electronic device; determining that the first electronic device is associated with a first user; accessing, from a personalization database and based on determining that the first electronic device is associated with the first user, a first profile associated with the first user; determining characteristics of the media provided by the second electronic device; accessing, from the personalization database and based on the characteristics of the media provided by the second electronic device, a tuning profile pertaining to the characteristics of the media; modifying first audio data provided by the second electronic device with the first profile and the tuning profile pertaining to the characteristics of the media; and outputting the modified first audio data through the first electronic device.

Clause 12. The method of clause 11, wherein the first profile and the tuning profile are stored within the personalization database in a storage block associated with the first user.

Clause 13. The method of clause 11, wherein the media provided by the second electronic device is speech of a second user, and wherein the characteristics of the media is an identity of the second user.

Clause 14. The method of clause 13, wherein the first media session further includes a third electronic device, wherein the determination that the second user is speaking through the second electronic device is at a first time, and wherein the method further comprises: determining, at a second time that a third user is speaking through the third electronic device; accessing, from the personalization database and based on determining that the third user is speaking, a tuning profile pertaining to speech of the third user and associated with the first user; modifying second audio data of the third user speaking with the first profile and the tuning profile pertaining to speech of the third user; and outputting the modified second audio data through the first electronic device.

Clause 15. The method of clause 13, wherein the identity of the second user is determined by correlating identifying information provided by the second electronic device to the second user and/or by determining vocal characteristics of the speaker and correlating the vocal characteristics to the second user.

Clause 16. The method of clause 13, wherein the determination that the second user is speaking through the second electronic device is at a first time, and wherein the method further comprises: determining, at a second time that a third user is speaking through the second electronic device; accessing, from the personalization database and based on determining that the third user is speaking, a tuning profile pertaining to speech of the third user and associated with the first user; modifying second audio data of the third user speaking with the first profile and the tuning profile pertaining to speech of the third user; and outputting the modified second audio data through the first electronic device.

Clause 17. The method of clause 11, wherein the characteristics of the media determined is a genre, title, and/or speaker of the media.

Clause 18. The method of clause 11, further comprising: establishing a tuning media session between at least the first electronic device and the second electronic device; determining that the media is provided during the tuning media session; outputting tuning audio data of the media through the first electronic device; receiving, from the first electronic device, tuning inputs to the tuning audio data; and storing, within the personalization database, the tuning profile pertaining to the media and associated with the first user, wherein the tuning profile is tuned by the tuning inputs.

Clause 19. The method of clause 18, wherein the tuning profile pertaining to the media and associated with the first user is accessed through a tuning profile lookup within the personalization database.

Clause 20. The method of clause 11, wherein the tuning profile pertaining to the media and associated with the first user is selected from a plurality of tuning profiles associated with the media and the first user.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and computer program products for source-dependent audio perception tuning of hearing assists. These drawings in no way limit any changes in form and detail that may be made by one skilled in the art without departing from the spirit and scope of the disclosed implementations.

FIGS. 1-3 are block diagrams illustrating system components for source-dependent audio enhancement, in accordance with certain embodiments.

FIGS. 4 and 5 are representations of certain aspects of source-dependent audio enhancement, in accordance with certain embodiments.

FIGS. 6 and 7 illustrate graphical user interfaces (GUIs) for source-dependent audio enhancement, in accordance with certain embodiments.

FIG. 8 is a block diagram illustrating system components for source-dependent audio enhancement, in accordance with certain embodiments.

FIG. 9 is a representation of certain aspects of source-dependent audio enhancement, in accordance with certain embodiments.

FIG. 10 is a block diagram illustrating system components for source-dependent audio enhancement, in accordance with certain embodiments.

FIG. 11 illustrates a GUI for source-dependent audio enhancement, in accordance with certain embodiments.

FIG. 12 is a block diagram illustrating system components for a media based source-dependent audio enhancement, in accordance with certain embodiments.

FIGS. 13 and 14 are flowcharts illustrating techniques for source-dependent audio enhancement, in accordance with certain embodiments.

FIG. 15 illustrates a block diagram of an example computing system, in accordance with some embodiments.

### DETAILED DESCRIPTION

### Introduction

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

It is appreciated that, for the purposes of this disclosure, when an element includes a plurality of similar elements distinguished by a letter or follow-on numeral following the ordinal indicator (e.g., “236A” and “236B” or “236-1” and “236-2”) and reference is made to only the ordinal indicator itself (e.g., “236”), such a reference is applicable to all the similar elements.

For the purposes of the following description, the terms “user”, “listener”, “speaker” and “talker” are used. The terms “speaker” and “talker” are used interchangeably to refer to a person whose voice is captured, transmitted or recorded, for instance in the context of a live communication or of entertainment content production or delivery. The terms “user” and “listener” are used interchangeably to refer to a person who is listening to audio outputted by an electronic device, transmitted or recorded. Such audio may be modified according to the techniques described herein.

The term “source signal” may represent a talker's voice, or, generally, any other kind of transmitted or recorded audio signal (for instance, a music or movie soundtrack component or “stem”), such as may be originated by one or more musical instruments, human character voices, sound effects, or any sound producing apparatus.

The term “profile” refers to a set of audio enhancement (or personalization) processing parameters.

Accordingly, in the following description, the terms “source”, “source signal”, “voice”, “talker voice”, and “speaker voice” are used interchangeably. Similarly, the adjectives “voice-dependent”, “talker-dependent”, “speaker-dependent”, and “source-dependent” are used interchangeably.

### Source-Agnostic Audio Processing

Reference is made in the following description to the “audio signal chain.” In order for people with hearing loss to be able to understand a source signal via electronic communication or transmission (including telephone calls and video conference calls such as Zoom or Teams for example), it is desirable to provide a product and/or service which generates an audio profile of the entire hardware and software signal chain from the source end to the listener end, and also accounts for the listener's hearing acuity or impairment.

Such an audio profile (referred to herein as the First Profile) may include, but may not be limited to: (1) information about the frequency response characteristics of the microphone associated with the call initiating device (e.g., cell phone, PSTN handset, headset microphone, and/or other such devices), the peculiarities and specifications of the audio processing effects associated with the network codecs, the response characteristics of the loudspeaker or loudspeakers associated with the listening device (e.g., cellular phone, PSTN handset, headset loudspeakers, computer loudspeakers, and/or other such devices), as well as (2) the specific hearing profile of the listener (audiogram-based prescription and associated response curve, noise reduction preferences, compression and wide dynamic range compression preferences, to name a short but not exhaustive list of elements associated with the “hearing profile” of the listener). This is because people with hearing loss may suffer from different levels of degraded hearing at different frequencies and/or may suffer from greater sensitivity to louder sounds (hyperacusis) at different frequencies.

Such a profile may allow for a user of an audio profile to utilize any electronic device that has audio outputs for hearing assists and, thus, allows for the user an enhanced hearing experience regardless of whether traditional hearing aids are used. The first profile allows for hearing enhancement to be provided by such electronic devices while taking into account the various characteristics of the audio output component of the electronic device.

An audio signal that is personalized to compensate not only for the devices being used to hear the signal, but also the specific and characteristic acoustic capability of the listener's ears (outer, middle and inner, including the cochlear response, where deficits account for the most common type of age-related hearing loss, sensorineural loss), enhances the hard-of-hearing listener's ability to understand speech when using such devices. The creation of a hearing profile for a listener based on the aforementioned elements enables a first level of customization (referred to herein as First Profile) designed, for instance, to enhance the ability of the listener to understand speech (note: “speech discrimination” is synonymous with “understanding of speech” and is the term customarily used in the audiology field) or to experience the psychoacoustic effect of music with greater fidelity to the original quality of the live audio or live streamed audio.

### Source-Dependent Audio Enhancement Processing Overview

While the aforementioned techniques may be used to generate a First Profile for a listener associated with a “typical” talker's voice or source signal, an additional variable affecting the audio listening experience may be accounted for in the systems and techniques described herein: the voice of the talker or, more generally, the characteristics of the source signal.

In the case of speech discrimination, the First Profile is configured to function in a personalization solution that takes into account an “average” of talkers' voices or source signals. Unlike the use case in which the subject wearing glasses can visually perceive for example, a young girl's face and a man's face with equal visual clarity, a subject with high frequency hearing loss using a sound personalization technology tuned for an “average” voice may have a much more difficult time understanding a young girl's voice than a man's.

Typical audiology speech testing uses recorded audio clips of a single voice, either male or female. Audiologists and hearing aid dispensers do not tune separate programs for different talker voices, and hearing aid devices do not contain different programs for different talker voices. Personalization tools, including predictive tuning and system tuning, can only be implemented using one to a handful of representative voices or source signals, for practical reasons. It would be far too burdensome, time consuming, and impractical to create a completely new hearing profile from scratch using those techniques with every single voice that a listener may encounter.

For people with hearing impairment, the typical “one-size-fits-all” hearing aid solutions do not work well for different listening environments or sounds. One of the frustrating aspects for hearing aid users is that, for example, any given program or setting that might be adequate for understanding a first voice (e.g., a deep-voiced man) might not be adequate for understanding a second voice (e.g., a child or woman with a higher-pitched voice), or vice versa.

Any given talker's voice has certain acoustic characteristics which are peculiar to that voice, notwithstanding the goal of the general hearing response profile algorithms to account for deficiencies in the listener's ability to hear certain frequencies. For example, a woman or a child would typically have a voice whose fundamental frequency or “enveloping” frequency would be higher pitched than that of a man. Given the same first-layer audio enhancement created for an “average” voice, this voice might be nonetheless harder for a hearing-impaired listener to understand than that of a man.

Furthermore, within the spectrum of human voices (e.g., women's or children's voices), there is a great range in terms of timbre, pitch, talking speed, enunciation, accent, etc. Broadening to other types of sound, such as music, media soundtracks, and/or other such sound, the acoustic characteristics of such sound may be even more variable than human voices. Furthermore, while a typical person tends to repeatedly listen to certain voices (e.g., the circle of friends, family, and business associates of the person), the amount of different media that a person listens to may be far greater and have far larger variability.

The tuning enhancement changes required to compensate for differences in sound (e.g., a faster-than-normal or slower-than-normal speech) might include, for example, not just changes in equalization, but also changes in wide dynamic range compression including, specifically, changes in the time domain parameters such as attack and release times of a digital signal processor (DSP) filter bank. The DSP filter bank (referred to herein as simply the “DSP”) may provide the processed audio to a user, according to the techniques described herein.

“Attack time” may be an example of a time constant. Attack time may be a parameter that is the rate at which the compression is applied at a given frequency or collection of frequencies, to the beginning of the phoneme, often called the “transient,” which might also be referred to as the onset of the phoneme or speech sound. A faster attack time means the compression is applied more aggressively (e.g., is more aggressively applied on the transient), and a slower attack time means that compression is applied more slowly. “Release time” refers to the rate at which the compression “tapers off” or “decays” at the end of a word or phoneme.

Described herein are systems and techniques for source-dependent audio enhancement processing. According to an aspect of the present invention, an additional layer of customization of audio enhancement tuning and processing, captured in a Source-Dependent Profile, is realized in association with an individual talker's voice or an individual source signal or category of source signals, as needed in accordance with the application use case. Such use cases may include, for example: (1) telephony and virtual meetings (enabling different Source-Dependent Profiles for one or several talkers); (2) movie soundtrack delivery (enabling different Source-Dependent Profiles for dialog, music, and sound effects); (3) music delivery (enabling different Source-Dependent Profiles for vocals vs. instrumental accompaniment). In certain embodiments, the systems and techniques described herein allow for control of various aspects of audio signals (e.g., attack and release times, comprehension thresholds, equalization parameters, and/or other aspects) in order to enhance speech understanding for a specific talker. The Source-Dependent Profile described herein allows for such adjustments on the fly, to respond to various different voices (e.g., from different talkers).

Accordingly, the systems and techniques described herein allows for identifying and applying personalized audio processing parameter settings for a listener with hearing loss and/or certain listening preferences. In certain embodiments, the systems and techniques described herein allow for a listener to create and recall a First Profile representing a set of audio enhancement processing parameters associated with the Listener and, optionally, a particular audio signal chain including an audio playback (or loudspeaker) device and/or an audio capture (or microphone) device by employing, for instance, the techniques described in U.S. Pat. No. 10,506,067 “Dynamic Personalization of a Communications Session in Heterogeneous Environments” and/or the techniques described in U.S. Pat. No. 9,933,990 “Topological Mapping of Control Parameters”, both of which are incorporated by reference in their entirety for all purposes. Additionally or alternatively, the systems and techniques described herein allow for a listener to create and recall an additional Source-Dependent Profile, representing an improvement, or deviation, from the First Profile, associated with a source signal or a category of source signals, such as, for instance, the voice of a given talker or a specific type of music or song.

During the operation of a system, the source signal may be analyzed in a variety of ways so as to associate with this source signal a Source-Dependent Profile. Certain embodiments of such systems are illustrated below and described in further detail via the description and figures included subsequently in the present document.

In certain embodiments, during an audio session (e.g., a communication session with a given talker or when listening to a given type of source signal), the listener who may have hearing loss has the option to: further tune his or her hearing profile (which may already contain sound personalization parameter settings based on techniques to identify hearing acuity in hearing impaired listeners, such as techniques described in U.S. Pat. No. 10,506,067 “Dynamic Personalization of a Communications Session in Heterogeneous Environments” and/or techniques found in U.S. Pat. No. 9,933,990 “Topological Mapping of Control Parameters”) to account for the particular peculiarities and idiosyncrasies of the sound present (e.g., the characteristics of a speaker's voice in order to maximize speech intelligibility of that particular speaker's voice) and save the changes to the signal processing parameters that result from this tuning in a unique address or location (e.g., save a profile that is associated with the speaker's voice), that would then be automatically retrieved and used by the system or manually selected by the listener in any subsequent communication session (including, but not limited to, media sessions, telephone calls, VoIP calls, computer conference calls, video conference calls, etc.) between the listener and this specific type of audio (e.g., specific talker or the listener and this specific talker on a multiparty communications session that includes additional participants). Once retrieved, the appropriate filter would be applied to the audio signal, thus tailoring the characteristics of the media's sound (e.g., each talker's voice) to the listener's speech discrimination needs and preferences associated with that given media (e.g., for that music or for the talker's voice).

Additionally or alternatively, a system, during a media session, may be configured make a recording. In the example of a conversation with a talker, the system may be configured to request permission of the talker to make a recording of the talker's voice (e.g., a thirty second to minute long clip) and record if permitted. A recording may then be generated that includes the voice of the talker or a set of properties characterizing the media in general. The recording may be digitally stored either in a temporary recording buffer or a permanent location that is accessible to the listener (also referred to as the “user”). The listener may then, at a subsequent time at his or her convenience, access the buffer or permanent location to retrieve the recording (or its characteristic properties), and perform the tuning enhancements at that time to account for the peculiarities and idiosyncrasies of the sound of the media in order to tune the characteristics of the sound to the listener's preferences (e.g., to maximize speech intelligibility of that particular talker's voice), replaying the recording as many times as necessary to optimize the “tuning” to the listener's satisfaction. The tuned profile, which may include the changes to the processing parameters that result from this tuning, may then be saved in a unique address or location associated with the user and/or listener.

Additionally or alternatively, an artificial intelligence (AI) system may be trained on the tuning preferences of the listener. The AI system may then determine the sound and/or speech preferences of the listener and automatically generate a profile for media and/or speaker that the listener interacts with or listens to. Such a profile may then be applied or may be provided to the user for further tuning.

The system may then automatically retrieve the new profile in any subsequent media session or the new profile may be manually selected by the listener in any subsequent media session (including but not limited to telephone calls, VoIP calls, computer conference calls, video conference calls, such as those between the listener and a specific talker) Additionally or alternatively, the system may (e.g., when the listener and this specific talker is on a multiparty communications session that includes additional participants) automatically select and apply the appropriate filter to the audio signal, thus tailoring each talker's voice to the listener's speech discrimination needs and preferences associated with that given talker's voice.

In certain embodiments, during a call with three or more participants or other multi-source transmission or listening application which involves a listener who may be hearing-impaired as well as two or more talker voices or source signals incoming from different locations (utilizing, for example, any combination of landline, VoIP, or cellphone technology), for which there may exist talker profiles associated with the voices of the talkers that are stored and accessible to the particular listener, a system may automatically detect and identify the various talkers on the call whenever they speak based on, for instance, one of several techniques, including detecting the IP computer address of the talker or source, detecting or recognizing the email address of call participants on a conferencing service such as “Zoom”, “Teams”, “Google Meet” etc., recognizing the PSTN number of the talker who is calling in, detecting the talker or source type based on pattern recognition techniques or AI systems, and/or detecting who is talking based on a software platform's technology for visually presenting the talker's camera and capturing their identity information using facial recognition or other software techniques to associate the speaking voice (based on lips moving) with a talker. The system may then automatically apply the appropriate talker-dependent or source-dependent profile whenever a given talker or source is active, thus tailoring each talker's voice or source signal to the listener's discrimination needs and preferences associated with that given talker's voice or source signal.

In certain embodiments, during a call with three or more participants or other multi-source transmission or listening application which might involve the listener and two or more talkers or sources sharing a single device (e.g., a speakerphone in a conference room setting shared by two or more talkers, or VoIP on a computer with audio speaker and microphone shared by two or more participants, such as a conference call speaker system), a system may be configured to automatically identify which talker or source is active and automatically apply the appropriate talker-dependent or source-dependent profile, thus tailoring each talker's voice or source signal to the listener's discrimination needs and preferences for that given talker or source.

In another embodiment, Artificial Intelligence-driven tuning may include an AI system comparing the sound signature of specific media (e.g., a talker's voice to presets in a lookup table of voices that are already indexed according to speech signature characteristics). In certain such embodiments, an approximate match may be utilized (e.g., instead of a complete match) to more quickly provide tuned profiles than having to wait for the listener to tune to a live or recorded talker voice.

In a further embodiment, tuning for certain media sound (e.g., a talker's voice, music, and/or a movie or television show, as well as other types of media) may include an AI driven system in which, after the listener, or the platform's aggregate collection of listeners, has set up a sufficient number of profiles using live or recorded techniques, the AI system may be configured to learn the range of sound characteristics and generate a library of sound signatures and recommend profiles for a given media's sound (e.g., talker's voice) if the voice profile is sufficiently similar to one in the library (e.g., in timbre, pitch, cadence, and/or other aspects).

A system may be configured to allow the listener to update a Source-Dependent Profile (or speaker profile) at any subsequent time, to take into account changes in the talker's voice or in the source signal's properties over time, as well as changes in the listener's hearing over time.

In a certain embodiment, the listener may tune the sound of the media or the character of the source signal for purposes of entertainment, rather than purposes of maximizing intelligibility. For example, the listener may wish to tune any given talker's voice in such a way that it changes or distorts the voice for comic, dramatic, or other effect, simply for entertainment value. Thus, the system may provide manipulation of frequency bands, wide dynamic range compression, frequency compression (also referred to as frequency transposition), or other types of audio digital signal processing parameters for distortion and entertainment purposes rather than, or in addition to, manipulation of one, some, or all such parameters in order to maximize speech intelligibility.

In a certain embodiment, the frequency response characteristic upon which at least one audio personalization parameter in the Source-Dependent Profile is based, is itself at least partly a function of at least one characteristic property of the source signal.

In another embodiment, in a multi-party communication or multi-source application, a Source-Dependent Profile may be modified dynamically during a real-time session, based on data provided by the listener, system, and/or another party, based on the system detecting which voice or source is active during a two-party or multiparty communication or music production session using source recognition and/or AI systems, based on detecting who is talking based on information about the computer address of the talker, and/or based on identifying who is talking based on the platform's technology for visually presenting the talker on camera and capturing that information to identify the voice. For example, a VoIP call may include a VoIP platform (e.g.: Zoom, Teams) that identifies the party that is talking based on the IP address of the talker or via email addresses of those who are participants in a meeting or other non-voice recognition techniques, or based on a combination of those methods including voice recognition.

Network topology may be described herein that includes a Personalization Node which may contain a database for storing hearing profiles, an audio signal processing engine, and a recording module. The Personalization Node may be configured to exchange data with participants' devices (such as commands or processing parameter values) via a communications interface (e.g., the Internet). Alternative embodiments may include deploying some or all of the components of a Personalization Node on a participant's electronic device (e.g., laptop computer, smartphone, and/or another such device).

### Recording

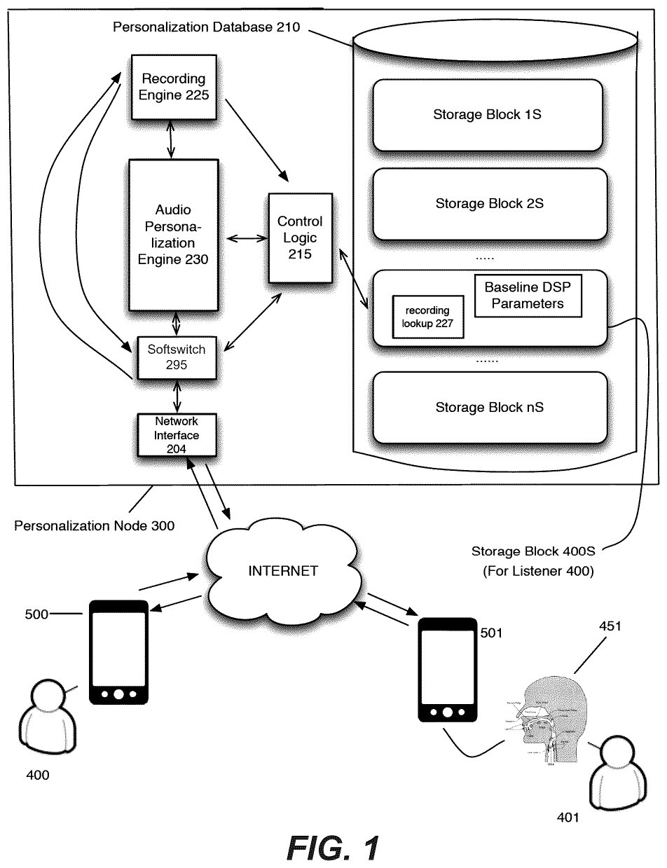

FIGS. 1-3 are block diagrams illustrating system components for source-dependent audio enhancement, in accordance with certain embodiments.

FIG. 1 depicts a network topology that provides for the establishment of a personal communication session, according to certain embodiments. Personalization node 300 provides for personalized communications based upon the preferences of individual users. Personalization node 300 is configured to establish and dynamically control call configuration between any users interacting with personalization node 300.

Personalization node 300 includes personalization database 210, a database of subscribers to the service. Personalization database 210 may store data for one or a plurality of users, including for user (“listener”) 400 in storage block 400S. Data associated with the various users of the system may be stored in storage blocks of personalization database, such as within storage blocks 1S-NS. This information may include a block containing baseline audio DSP parameters, as well as recording lookup block 227, which will be described further.

Personalization node 300 also may include recording engine 225. Recording engine 225 is configured to record digital audio streams provided by personalization node 300 via network interface 204 and audio personalization engine 230, originating in either speaker 401 and/or listener 400. Thus, in certain embodiments, the audio stream recorded by recording engine 225 is audio that has already been processed by audio personalization engine 230 according to the “hearing profile” (e.g., “First Profile”) DSP parameters associated with listener 400.

In certain embodiments, personalization node 300 generally or various components of personalization node 300, such as audio personalization engine 230, may be located within a server device or an electronic device of listener 400 (e.g., within electronic device 500), as well as other devices.

Recording engine 225 may store the recording of the digital audio stream in a temporary buffer and may also output the recording to personalization database 210. In certain embodiments, the recorded audio may be transmitted to the storage block associated with listener 400 that is located inside personalization database 210 and stored in recording lookup block 227 associated with listener 400.

Speaker 401 may speak with voice 451. Voice 451 represents the characteristic voice whose speech element will be recorded in the example of FIG. 1, but in various embodiments, voice 451 may be any voice of any speaker and/or any type of sound. It is appreciated that, in various embodiments, the systems and techniques described herein may be utilized to tune audio profiles that may apply to all types of media, including music, podcasts, and movies, and not just to the voices of specific speakers. However, for illustrative purposes, a conversation between the listener and a speaker may be provided as an example.

Recording engine 225 is a dynamic digital recording mechanism which can be switched on and off by participant 400 during an established communications session. In various embodiments, recording engine 225 may, for example, be configured to receive permission from one or more participants (e.g., speaker 401 and/or listener 400) before proceeding to record a conversation. Recording engine 225 may be any type of appropriate digital recording algorithm.

Electronic device 500 may be any type of electronic device, such as a smartphone, laptop, desktop, server, wearable electronic device, and/or another such electronic device. Electronic device 500 may be used by listener 400 to control recording engine 225 (e.g., switching recording engine 225 on or turning recording engine 225 off). In certain embodiments, electronic device 500 may also be utilized to perform the communications session or provide media, but other embodiments may utilize one electronic device to perform communications or provide media and another electronic device to control recording engine 225. For example, a public switched telephone network (PSTN) handset may be utilized for the communications session and recording may be controlled by, for example, the appropriate dual tone multi-frequency (DTMF) code. Such an embodiment may communicate instructions regarding switching of recording engine 225 by electronic device 500 through, for example, softswitch 295 via network interface 204 to recording engine 225. Softswitch 295 may be a switching node.

In various embodiments, accessing of personalization database 210, switching (by softswitch 295), operation of audio personalization engine 230, and/or operation of recording engine 225 may be controlled by control logic 215. Control logic 215 may, in various embodiments, be implemented as one or more instructions stored within memory of an electronic device (e.g., within a harddrive). Such instructions may, when accessed, cause a processor to perform operations as described herein.

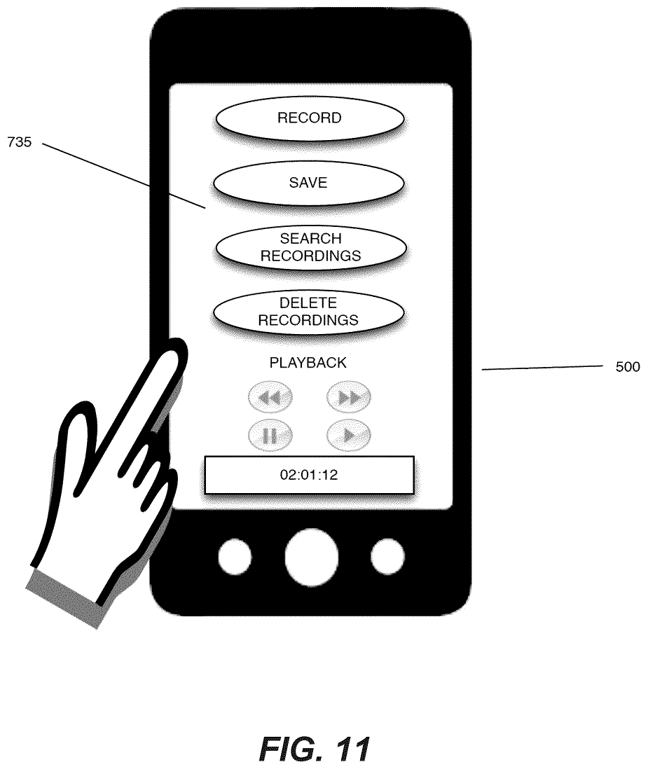

FIG. 11 illustrates a GUI for source-dependent audio enhancement, in accordance with certain embodiments. The GUI of FIG. 11 may be utilized to control recording engine 225. Thus, FIG. 11 depicts recording controller 735 which allows listener 400 to switch on or off recording engine 225 by entering an “on” or “off” command on electronic device 500. Based on the input from the user, data directed to the appropriate command is communicated over the appropriate communication network (e.g., the Internet, which may be labeled in the Figures here) directly to personalization node 300, and then to recording engine 225.

Recording lookup 227 may be configured to store digital audio clip recorded by recording engine 225. Recording lookup 227 may include an array of temporary digital buffer(s), an array of permanent storage block(s), or an array of rewritable storage block(s), and/or any combination thereof.

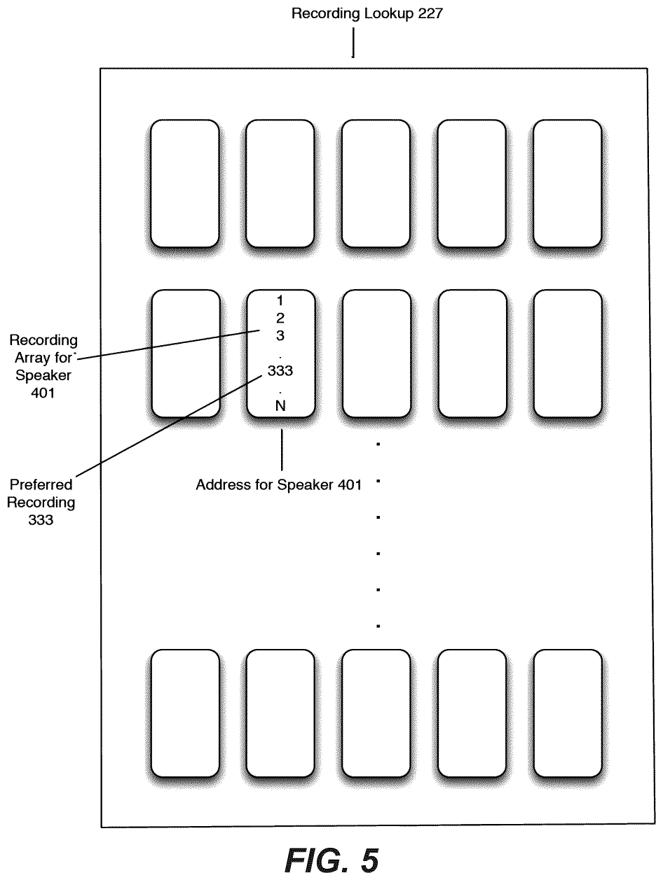

FIG. 5 depicts one possible embodiment of recording lookup 227. In FIG. 5, recording lookup 227 may be a storage block inside storage block 400S which contains within it a lookup table that identifies addresses of different recordings made by listener 400. Each address may be associated with a specific participant (e.g., participant 401) or media. Each address may include an array of recordings 1 to N, each of which may be accessed for processing as desired (e.g., when appropriate data indicating a request for access is received). In various embodiments, recording slot 1 to N may be written over and/or saved permanently. In certain embodiments, listener 400 and/or talker 401 may provide an indication to write over or save permanently one or more recordings associated with slots 1 to N via recording controller 735 shown in FIG. 11.

Listener 400 may save the recording to the recording lookup 227 (e.g., after listener 400 is satisfied with a recording made of participant 401's voice 451). In certain embodiments, an indication may be provided (e.g., with an identifying label) that such a recording is a preferred recording (e.g., preferred recording 333). Alternatively, talker 401 may save several recordings of the media (e.g., of participant 401's voice 451) and elect not to identify a preferred version until subsequent playback.

### Playback

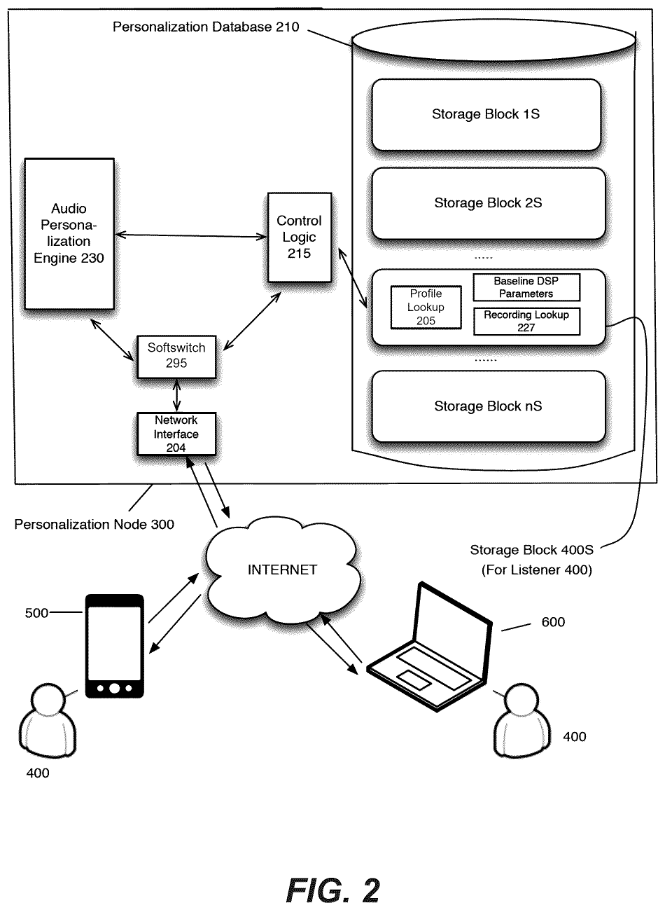

FIG. 2 depicts a network topology and the establishment of a “playback and tuning” session of a recording stored in recording lookup 227, between the listener 400, and the personalization node 300. The listener may choose to initiate the playback and tuning session from cell phone 500, from computer 600, or from a PSTN line using DTMF inputs or voice commands to control the tuning.

In certain situations, listener 400 may select a preferred recording 333 or may play back recordings of participant 401's voice 451 stored in recording lookup 227 (e.g., as such in FIG. 5) and select a recording to process. In certain embodiments, a recording designated as a preferred recording may be automatically selected. Once a recording is selected, listener 400 may send a command via recording controller 735 (e.g., displayed on electronic device 500) to play back the recording through audio personalization engine 230. The recording may, thus, be used as the input audio file to be processed by audio personalization engine 230.

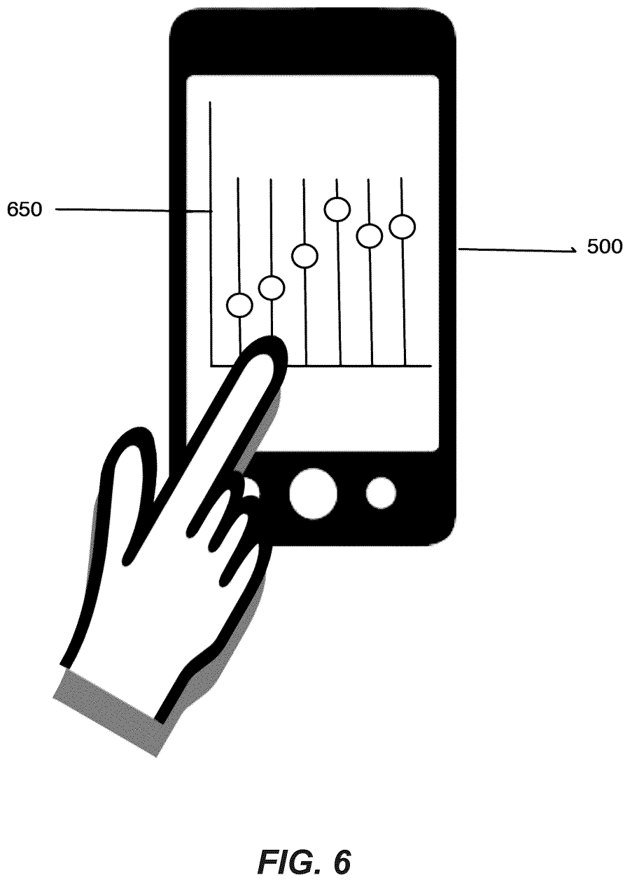

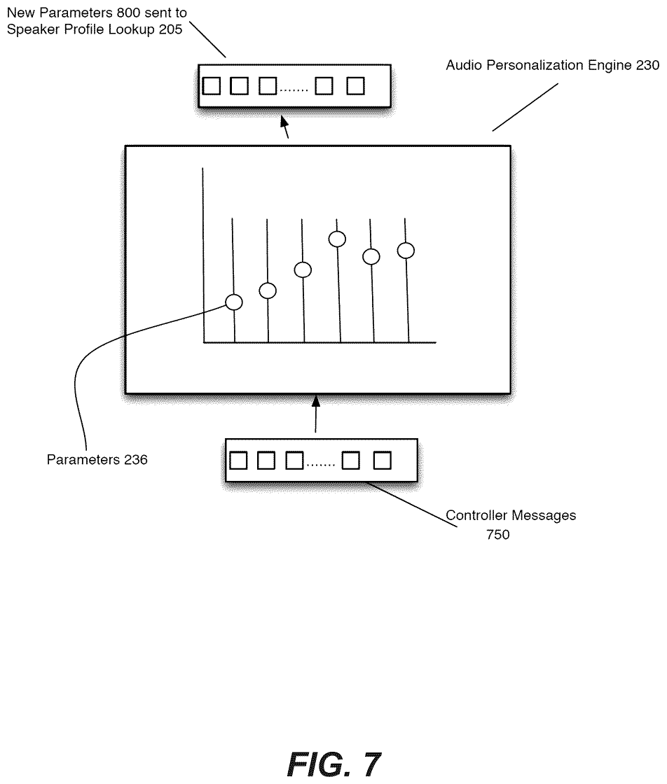

FIGS. 6 and 7 illustrate graphical user interfaces (GUIs) for source-dependent audio enhancement, in accordance with certain embodiments. FIG. 6 depicts tuning controller 650, which may be presented as a GUI on electronic device 500. Electronic device 500 may include a user interface that allows listener 400 to send commands to audio personalization engine 230. Tuning controller 650 allows listener 400 to control audio personalization engine 230 and provide data to cause audio personalization engine 230 to perform tuning operations on recording 333 or any other recording in real time or semi-real time (e.g., in a manner that allows for a listener to provide adjustments while listening to a conversation that is outputted to the listener). In various embodiments, such tuning by audio personalization engine 230 may be via a digital signal processor (DSP) filter bank or other appropriate technique.

For example, listener 400 may wish to alter the frequency response of the audio recording by adjusting the parameters in the equalizer contained in audio personalization engine 230. Alternatively, listener 400 may wish to alter the compression thresholds as a function of frequency, or the attack and release times, as described herein. Listener 400 may also wish to adjust the parameters associated with “Frequency Transposition” or “Frequency Compression”, two DSP algorithms, if such algorithms are available and would be helpful to audio enhancement for listener 400. The algorithms described herein are examples and are not an exhaustive list. Audio personalization engine 230 may be equipped with any number of signal processing algorithms, not limited to those described herein.

As listener 400 adjusts parameters in tuning controller 650, tuning controller 650 provides data (e.g., controller messages 750) to audio personalization engine 230. Controller messages 750 may be configured to change DSP parameters 236 in audio personalization engine 230. FIG. 7 provides an example of controller messages 750.

In certain situations (e.g., once listener 400 is satisfied with the modifications made to the preferred recording), listener 400 may provide input to cause tuning controller 650 to send a data including a controller message to audio personalization engine 230 to save the modifications. Audio personalization engine 230 may then save the updated DSP parameters associated with the preferred recording and output them to profile lookup 205. The updated DSP parameters may be saved with data indicating association with speaker 401 (e.g., associating with an account of speaker 401) and may represent the listener “preferences” associated with speaker 401.

FIG. 2 illustrates profile lookup 205 contained within Storage Block 400S, which is stored within personalization database 210 contained within personalization node 300.

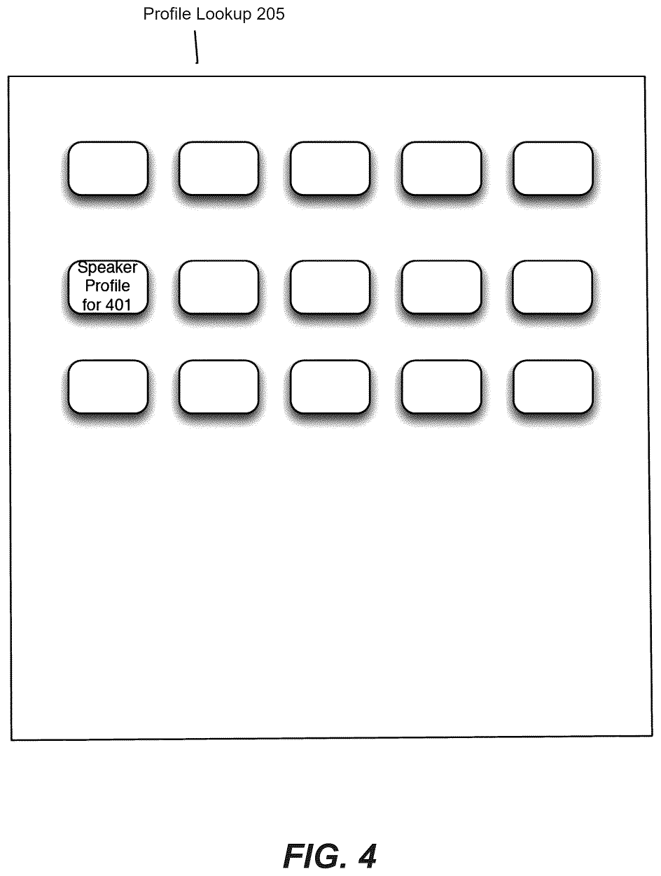

FIG. 4 depicts further details of profile lookup 205. Profile lookup 205 contains individual talker profiles, indexed by address. These talker profiles reflect the listener preference associated with a given talker or contact. In certain embodiments, such preferences may result in a collection of uniquely selected DSP parameters generated by audio personalization engine 230 at the direction of listener 400. In certain embodiments, profile lookup 205 may be included within storage block 400S for listener 400 and may store an array of individual talker profiles. One such individual talker profile may be associated with talker 401. In certain other embodiments, the structure of profile lookup 205 may be utilized for other types of media. Accordingly, there may be a plurality of different profiles for music, media, podcasts, and/or other such media and such plurality of profiles may also be stored within profile lookups similar to profile lookup 205.

Referring back to FIG. 1, additionally or alternatively, the system of FIG. 1 may provide for a subsequent communication session between listener 400 and participant 401. In any such subsequent communication session, personalization node 300 may automatically access the speaker profile lookup associated with talker 401 (from profile lookup 205) for listener 400, transfer the associated DSP parameters to audio personalization engine 230 or electronic device 500 (which may include its own audio personalization engine 230), and use them to process the telephonic audio stream from talker 401 (voice 451) to listener 400 during the communication session.

### Real Time Tuning

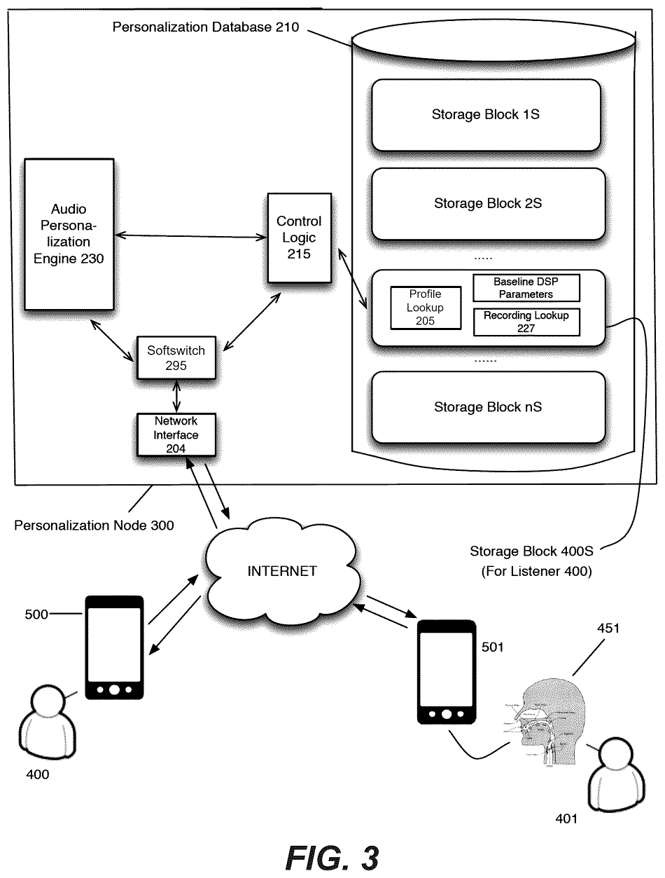

FIG. 3 depicts a network topology and the establishment of a media session, according to an embodiment. Personalization node 300 provides for output of audio based upon the preferences of individual users. Personalization node 300 is configured to establish and dynamically control the configuration of any media session, such as a communication session between any users interacting with personalization node 300.

As shown in FIG. 3, personalization node 300 may include audio personalization engine 230 and profile lookup 205, contained within storage block 400S of personalization database 210.

Listener 400 may provide inputs (e.g., via a GUI on electronic device 500) to tuning controller 650 to cause tuning controller 650 to send data that includes instructions to audio personalization engine 230 to modify DSP parameters that are being applied to the audio signal during the media session. Such modifications may, for example, enhance listener 400's understanding of participant 401's speech, or for any other purpose.

FIG. 6 illustrates tuning controller 650. Tuning controller 650 may provide a GUI that allows for listener 400 to interactively alter DSP parameters through interaction with the GUI. For example, during a personal communication session with participant 401, listener 400 may utilize tuning controller 650's GUI to alter such parameters. Tuning controller 650 would then send data (e.g., a real time or near real time message or series of messages) to audio personalization engine 230.

FIG. 7 illustrates controller messages 750, which represents the data stream provided by tuning controller 650 to audio personalization engine 230. Controller messages 750 may include data that causes adjustment of parameters 236 of audio personalization engine 230. Parameters 236 may include, for example, compression thresholds as a function of frequency and time domain parameters such as attack and release times.

Based on the adjustment of parameters 236 of audio personalization engine 230, new parameters 800 may be provided to profile lookup 205 from audio personalization engine 230. In various embodiments, new parameters 800 may include all such parameters 236 (e.g., both parameters that are changed as well as parameters that are unchanged) or may include only the parameters 236 that are adjusted.

Referring back to FIG. 3, FIG. 3 illustrates electronic device 500 and electronic device 501. Various embodiments of electronic device 501 may include any electronic device associated with the depicted media session including, but not limited to, cell phone, computer (for a VoIP call, for example), server, PSTN line, etc. Various embodiments of electronic device 500 may include any electronic device associated with the depicted personal communication session, including, but not limited to, cell phone, computer (for a VoIP call, for example), server, PSTN line, etc.

In various communication sessions, audio personalization engine 230 may apply the updated DSP parameters contained in data stream 750 in real time, or near real time, to the audio signal being sent from device 501 to device 500, thus changing the audio signal characteristics of the media session. Such characteristics may be changed in real time or near real time. Thus, the characteristics of the voice of speaker 401 that is outputted to listener 400 via electronic device 500 may be modified (e.g., to aid in listener 400 understanding voice 451 of speaker 401). The characteristics may be adjusted (e.g., via adjustments to the DSP parameters) until listener 400 is satisfied with the character of the audio signals and decides to cease inputting modifications to tuning controller 650.

Listener 400, using device 500, may elect to save the associated DSP parameters to profile lookup 205 (e.g., as a “preference” to be accessed and used by the audio personalization engine 230 during any future conversation with participant 401 or another speaker). Such profiles may be saved if, for example, listener 400 is satisfied with the character of the audio signal during the personal communication session.

Once the DSP parameters are saved, listener 400 may interact with electronic device 500 to cause tuning controller 650 to send a command to audio personalization engine 230 to transfer these DSP parameters and save them to profile lookup 205, which is located in Storage Block 400S. FIG. 4 depicts profile lookup 205, where the aforementioned selected parameters are stored with a unique address referring to speaker 401, as described herein.

In any subsequent re-establishment of a media session between listener 400 and electronic device 501, upon initiation of the media session, personalization node 300 may correlate electronic device 501's and/or the media provided by electronic device 501's identifying information (e.g., identifying number, account information, account number, IP address, MAC address, telephone number, VoIP identification address, and/or other such identifying information) with a profile lookup address associated with participant 401, electronic device 501, and/or the media being provided and automatically access the associated profile in profile lookup 205. The DSP parameters associated with the speaker profile may then be transferred to audio personalization engine 230, electronic device 500, and/or a DSP filterbank in electronic device 500 or an analogous audio personalization engine that resides in electronic device 500, which would use these parameters to process the audio signal from electronic device 501, participant 401 (voice 451), and/or the media during the media session.

### Profile Selection in a Multi-Party Session

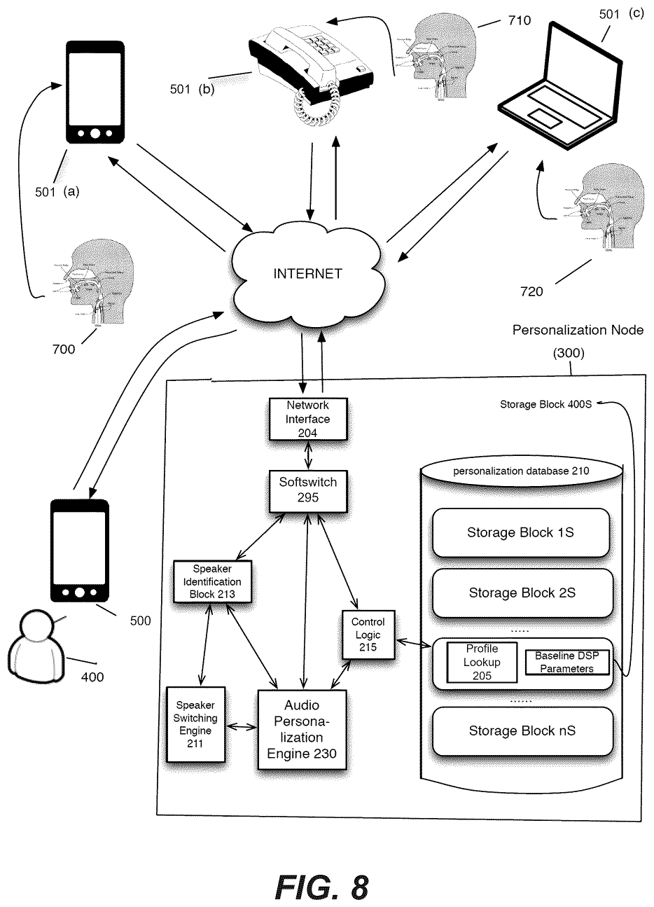

FIG. 8 is a block diagram illustrating system components for source-dependent audio enhancement, in accordance with certain embodiments. FIG. 8 depicts a network topology and the establishment of a communication session, according to one embodiment. Personalization node 300 shown in FIG. 8 provides for communications based upon the preferences of individual users. Personalization node 300 is configured to establish and dynamically control the configuration of communications sessions between any users interacting with personalization node 300.

FIG. 8 depicts a communication session that includes four participants. Other embodiments of such communication sessions may include any number of three or more participants (typically referred to as a multi-party or conference call). In the case of FIG. 8, each participant on the session is communicating via a separate device and/or from a different location (e.g., as distinguished from a “speakerphone conference room call” in which two or more participants are gathered around a single speakerphone, VoIP device, cell phone using “speaker” function, or any other device which can transmit two or more takers' voices over the same channel).

For the purposes of clarity, “speaker” as referred herein pertains to a participant whose unique speaker profile will be enabled during the communication session in order to enhance the audio quality for the listener (e.g., listener 400 in FIG. 8).

In certain embodiments, participants 700, 710, and 720 may previously have respective speaker profiles created and stored in profile lookup 205 which are associated with listener 400. Thus, for example, pre-adjusted speaker profiles adjusted for each of participants 700, 710, and 720 may be associated with listener 400 and stored within one or more databases. In certain embodiments, not all participants, or none at all, may require speaker profiles stored in profile lookup 205. In such an example, where speaker profiles associated with listener 400 have not been created for all participants, specific speaker profiles may be applied to participants whose speaker profiles associated with listener 400 are stored within profile lookup 205.

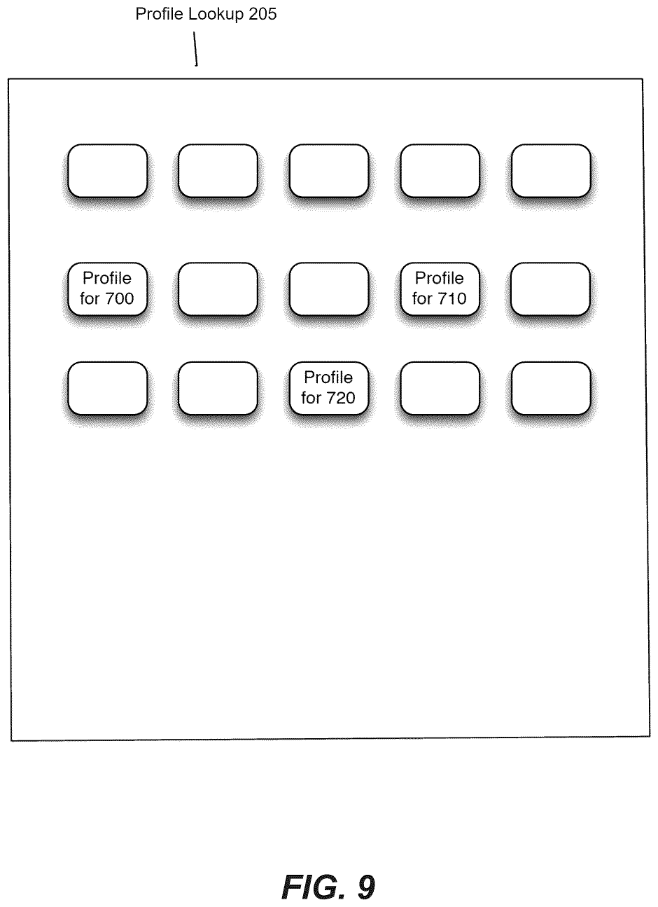

FIG. 9 is a representation of certain aspects of source-dependent audio enhancement, in accordance with certain embodiments. Profile lookup 205 may store speaker profiles for participants 700, 710, and 720, among others. Upon initiation of the communication session, personalization node 300 correlates each of the participants' 700, 710, and 720 identifying information with the associated profile lookup 205 addresses which contain the associated speaker profiles for participants 700, 710, and 720, respectively.

During the communication session, speaker identification block 213 is configured to identify which of speakers 700, 710, and/or 720 is active at any given time. Such identification may be performed by, for example, speaker recognition techniques which employ pattern-matching, voice biometrics, artificial intelligence-driven voice identification, and/or other such techniques. Such examples are for illustrative purposes only and are not intended to be limiting. Alternatively or additionally, personalization node 300 may identify which participant is talking at any given time by identifying the channel that is the source of the audio signal at any given time during the session. In various embodiments, different channels (e.g., communication channels) are associated with different active devices. Thus, identifying the different channel associated with the various active devices allow personalization node 300 to identify which participant is talking in the communications session.

After speaker identification block 213 has identified the speaker, speaker switching engine 211 notifies audio personalization engine 230, at which point audio personalization engine 230 accesses the respective speaker profile DSP parameters from profile lookup 205. In certain such embodiments, the respective speaker profile DSP may include identifying information and/or an address that corresponds to the participant who is talking.

Audio personalization engine 230 may then update the processing of the audio signals by automatically selecting the appropriate profile and applying the respective DSP parameters to the audio signal before outputting the audio to listener 100 via an audio output component (e.g., headphones, earbuds, speaker, or other output device) of electronic device 500. Additionally or alternatively, listener 400 may manually select the preferred profile associated with any of speaker 700, 710 or 720.

During a communications session, speaker identification block 213 may continuously monitor the communications session and adjust as necessary. For example, the DSP parameters that are applied (e.g., according to a speaker profile) may be changed if a different speaker is detected. For example, if the voice of the speaker changes (e.g., in frequency, pitch, tone, accent, cadence, or another aspect), speaker identification block may provide data to speaker switching engine 211 indicating the change. Speaker switching engine 211 may then provide data to audio personalization engine 230 indicating that a change of speaker is detected. The identity of the new speaker may be determined (e.g., from the characteristics of the voice and/or from the communications channel). Audio personalization engine 230 may then access the respective speaker profile DSP parameters that corresponds to the new speaking participant from the profile lookup 205. As such, whenever speech of a new participant is detected, the listener's audio signal is modified according to the speaker profile DSP parameters associated with the new speaking participant.

In various embodiments, there may be more than one listener within the system. In such an embodiment, personalization node 300 processes audio signals during the communications session according to each listener's personal hearing profile, as well as each listener's associated speaker profile based on the participant that is speaking. Each listener's speaker profile may be located within each listener's unique profile lookup 205. It is appreciated that, though the plurality of listeners may each be listening to the same speaker, each listener may include speaker profile lookups for the speaker that are different from each other.

Profile Selection when Speakers Share a Channel

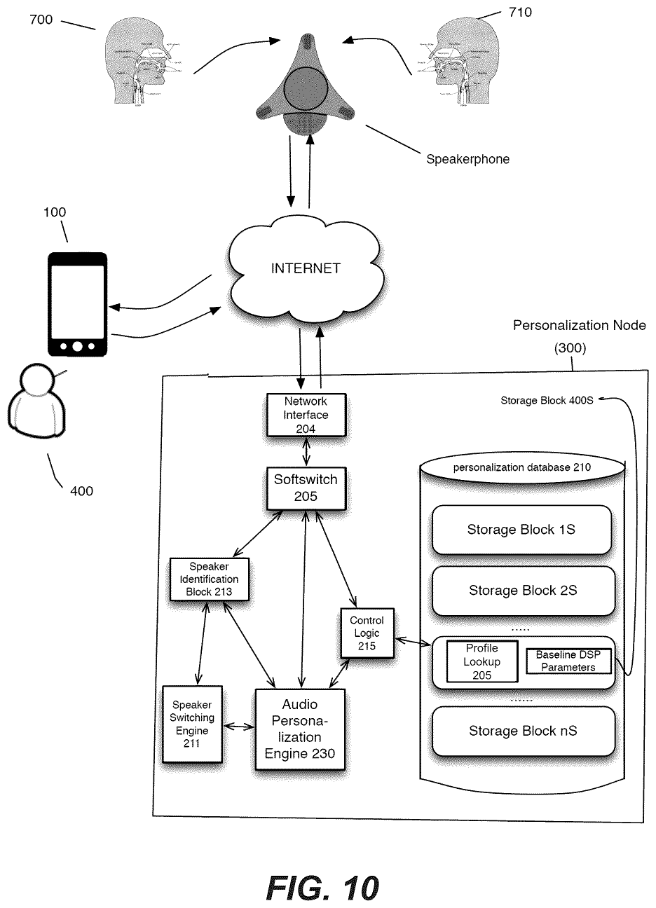

FIG. 10 is a block diagram illustrating system components for source-dependent audio enhancement, in accordance with certain embodiments. FIG. 10 depicts a network topology and the establishment of a communication session, according to one embodiment. Personalization node 300 provides for personalized communications based upon the preferences of individual users. Personalization node 300 is configured to establish and dynamically controlled call configuration between any users interacting with personalization node 300.

In certain embodiments, FIG. 10 may illustrate a communication session that includes three participants, but various other embodiments may include any communication session between three or more participants (typically referred to as a multi-party or conference call). In the case of FIG. 10, two or more participants in the call, referred to herein as talkers, are speaking into the same device (e.g., a speakerphone, VoIP device, cell phone using the speaker function, or any other device which can transmit two or more participants' voices over the same channel).

In certain embodiments, listener 400 has previously created and stored speaker profiles for participants 700 and 710 in profile lookup 205. Additionally or alternatively, listener 400 may have speaker profiles stored in profile lookup 205 for only a subset of the participants. In the embodiment where not all participants have existing speaker profiles stored within listener 400's profile lookup 205, only the voices of participants whose speaker profiles exist in listener 400's profile lookup 205 may be affected by the speaker profile.

During the communication session, speaker identification block 213 may identify the participant that is speaking (e.g., participant 700). In this embodiment, speaker identification block 213 may not be able to know which technique to use to identify the first talker (e.g., identify participant 700). Thus, speaker identification block 213 may employ a software algorithm to compare the communication channel being used with the voice that is speaking. If the voice and channel match (e.g., certain voices may be associated with specific communication channels, such as a specific IP address) and are associated with a speaker profile in the listener's speaker profile lookup, then speaker identification block 213 may provide data to speaker switching engine 211 indicating as such. Speaker switching engine 211 may then provide data to audio personalization engine 230 to access the corresponding speaker profile whose address corresponds to participant 700, the speaker, from the profile lookup 205.

Speaker identification block 213 may monitor the communications session continuously. If speaker identification block 213 determines that a new participant is speaking (e.g., participant 710), speaker identification block 213 may determine that there is a change of speaker. Speaker identification block 213 may not detect a change in channel, since the communication channel has not changed as both participants 700 and 710 utilize the same communication channel. Thus, speaker identification block 213 may determine a change in voice according to the techniques described herein and, based on the channel not changing, may deduce that participant 700 and participant 710 are speaking on the same channel. Accordingly, speaker identification block 213 may utilize the speaker recognition techniques described herein (which may employ pattern-matching, voice biometrics, artificial intelligence-driven voice identification, and/or other known methodologies) to identify the new speaker. Speaker identification block 213 may then provide data to speaker switching engine 211 indicating the determined change of speaker. Speaker switching engine 211 may then provide data to audio personalization engine 230 that causes audio personalization engine 230 to access and use the talker-dependent DSP parameters associated with the characteristics of the speaker that corresponds to participant 710 from profile lookup 205. Accordingly, whenever a new participant speaks, the listener's audio signal is modified according to the speaker profile associated with the new talker.

### Media Source Audio Processing

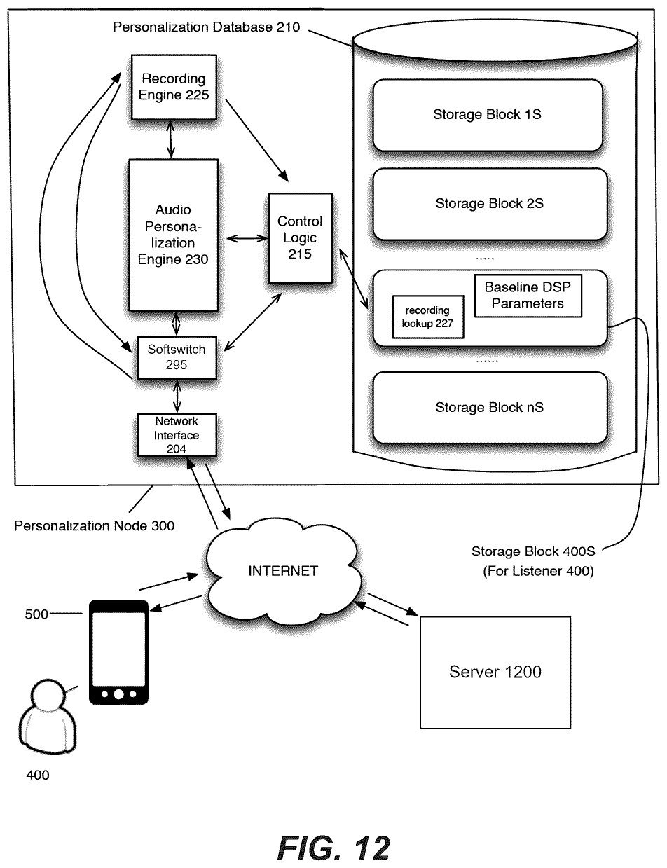

FIG. 12 is a block diagram illustrating system components for a media based source-dependent audio enhancement, in accordance with certain embodiments. In FIG. 12, listener 400 may be listening to media (e.g., music, video, recordings such as podcasts, and/or other such media, including any type of educational, professional, or entertainment media) provided by server 1200 (e.g., the media may be served and/or stored within a database of server 1200).

In various embodiments, storage block 400S may include one or more profiles for modifying the audio (e.g., DSP) parameters of media. In certain embodiments, a plurality of profiles may be stored within storage block 400S. For such a plurality of profiles, the various profiles may be specific to a certain media (e.g., a certain show, a certain movie, a certain episode, a certain speaker within media, and/or other specific applications including the title, track, album, episode, and/or other such identifying information), to a certain genre of media (e.g., to movies, music, or podcasts in general, or to a certain category of movies, such as action, music, such as rock, or podcasts, such as children's shows), to media provided by a specific entity (e.g., all media produced by a certain company or provided by a specific server), and/or for other such categories. Such profiles may be created and/or tuned by listener 400, generated by personalization node 300 (e.g., from a baseline profile) and tuned by listener 400, and/or generated and/or tuned by personalization node 300 via an automatic process as described herein.

Personalization node 300 may allow for listener 400 to access and/or tune profiles, according to the techniques described herein. Thus, listener 400 may tune profiles associated with various media or types of media. Thus, for example, listener 400 may load a profile (e.g., a baseline profile) or select a pre-existing profile or such a profile may be automatically loaded and/or selected for the user. Listener 400 may then listen to media (e.g., a movie or a song) and tune the profile based on listener 400's preferences. Such a profile may then be saved within storage block 400S and associated with the media or type of media.

Personalization node 300 may select tuning profiles that best match that of the sounds of the media that are being output (e.g., in real time or near real time). Thus, for example, personalization node 300 may generate a tuning profile for the media based on the preferences of listener 400. The sounds present in the media may be compared to other profiles of the user. Accordingly, personalization node 300 may determine that a podcast has a host with a deep voice. Personalization node 300 may then determine the tuning profiles of listener 400 that is directed to speakers with deep voices. The tuning profile directed to a voice matching the host may be selected by personalization node 300.

Additionally or alternatively, personalization node 300 may automatically generate profiles for the media, in real time or near real time, for a media session. Such automatically generated profiles may be based on previously stored profiles (e.g., a profile for a similar output may be used as a baseline or for training purposes for an AI system) and/or generated by an AI system that may utilize the listener's stored profiles as training data. Certain embodiments that utilize previously stored profiles may conduct additional tuning on such profiles, whether manually or automatically by personalization node 300, as per the techniques described herein.

Accordingly, as an example, a person with hearing loss who suffers from a deficiency in speech understanding may wish to create a hearing profile that elevates the dialogue component of a movie above the music and sound effects components. The profile may provide such elevation through manual tuning by the user and/or automatically. For example, personalization node 300 may identify dialogue, either through AI processes or based on metadata within a program identifying various sound components as dialogue. Thus, a heuristic or AI-driven algorithm may be used to separate the dialogue from the music and sound effects in general. Furthermore, as a media program may have a multitude of sounds or audio tracks, audio data may include data or metadata that identifies the dialogue components, music, sound effects, different portions of a music composition, different speakers, and/or other such different audio components or audio tracks. Such data or metadata may be utilized to identify specific aspects of the sound components of the media that may have profiles applied against to tune such sound components.

From such a profile, further tuning of the dialogue component may be performed to more precisely conform the dialogue component to listener 400's specific hearing ability, whether through manual or automatic techniques described herein. Thus, listener 400 may no longer need to rely on captions to understand the dialogue, and may, instead be able to appreciate and enjoy the dialogue in the manner in which the filmmaker or artist intended when they spent, potentially, months mixing it in the mixing room for an audience that typically has “normal” hearing. Such profiles may be saved and associated with the media (e.g., episode or movie) and, in certain situations, audio personalization engine 230 may automatically load such a profile if playback of the media (e.g., subsequent playback of the movie, of the episode, and/or of another episode in a series of episodes) is determined. Thus, such profiles may be created for one episode and used for all episodes in a series, as generally the audio characteristics of a series is fairly similar across all episodes and typically include similar voices.

Thus, such tuning profiles may be accessed from storage block 400S and communicated to audio personalization engine 230, whereupon audio personalization engine 230 may utilize the profile for modification of DSP parameters or perform tuning of such a profile (e.g., to better match listener 400's preferences) before using the tuned profile to modify DSP parameters. Additionally or alternatively, audio personalization engine 230 may receive data from storage block 400S and generate a tuning profile from such data (e.g., based on the listener's preferences or diagnosed conditions). Generation of such tuning profiles may be according to the techniques described herein. It is appreciated that, as media includes a large category of different types, styles, durations, and/or other aspects of recording and audio outputs, automatic tuning or generation may be utilized to allow for accommodation of the vast amount of different media.

Audio personalization engine 230 may then apply the tuning profile to modify the DSP parameters to generate modified audio data and provide the modified audio data to electronic device 500 or provide the tuning profile to electronic device 500 for modification of audio data to be outputted to listener 400. The modified audio data may then be output by electronic device 500 to listener 400.

The modified audio data may be configured to enhance listener 400's listening experience. Enhancement of such experience may include, for example, allowing for listener 400 to better understand speech or tones, enhancement of certain sounds that is enjoyable to listener 400, providing for greater clarity, and/or other such enhancements.

### Source-Dependent Technique

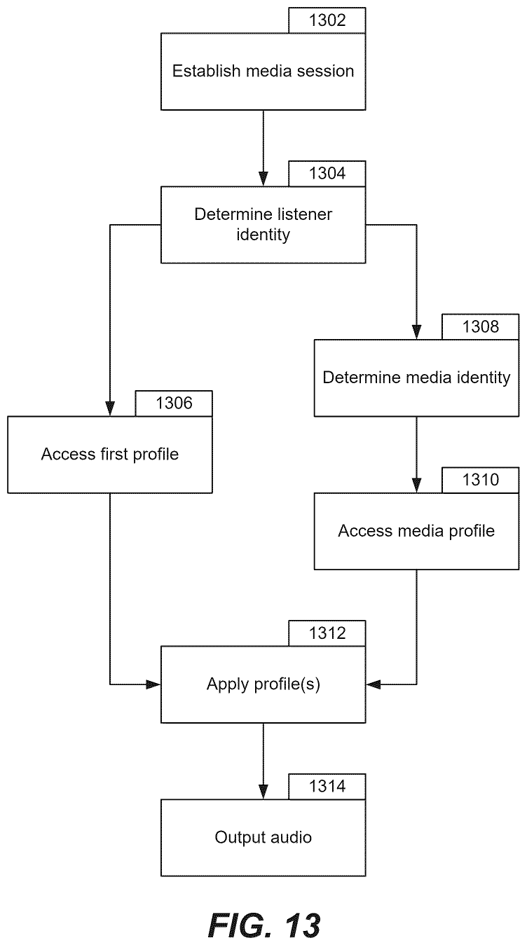

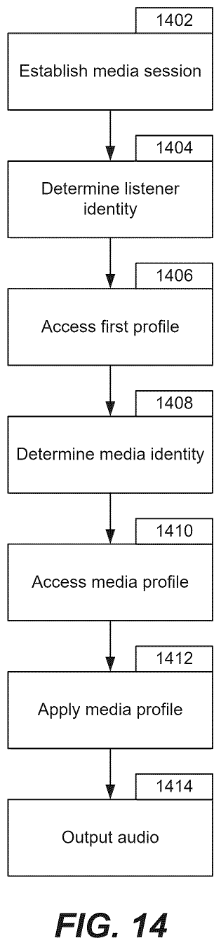

FIGS. 13 and 14 are flowcharts illustrating techniques for source-dependent audio enhancement, in accordance with certain embodiments. The techniques illustrated in FIGS. 13 and 14 may incorporate the techniques for creating, determining, and selecting profiles and processing audio as described herein.

As shown in FIG. 13, in 1302, a media session may be established. At any point of the session, the media session may include any number or media or different types of sounds and/or a plurality of participants such as a listener and speaker. The listener may be associated with an account associated with the personalization database and may include a first profile as well as one or more tuning profiles stored within a profile lookup.

In 1304, the system may determine the identity of the listener. Such identification may be performed through any technique described herein, including through data provided by the electronic device indicating that the user wishes to log into an account associated with the user within the system for source-dependent audio enhancement. Thus, the system may determine that a first user is logged into an account for audio enhancement. Based on the first user not speaking or audio data not being outputted by the first electronic device associated with the first user, the system may determine that the first user is the listener.

In 1306, based on the identity of the user, the first profile may be accessed. The first profile may include, but may not be limited to data that modifies audio data based on the frequency response characteristics of the microphone associated with the electronic device of the first user, the peculiarities and specifications of the audio processing effects associated with the network codecs, the response characteristics of the speakers associated with the electronic device, the specific hearing profile of the first user (e.g., audiogram-based prescription and associated response curve, noise reduction preferences, compression and wide dynamic range compression preferences, and/or other such elements), and/or other such elements.

In 1308, the identity of the media (e.g., identity of speaker, genre of media, specific track or song, part of the media being played, and/or other such information pertaining to the sound being output) may be determined. In certain embodiments, the speaker may be a speaker using a second electronic device and the communication session may be conducted over a network with the system via the first electronic device of the first user and a second electronic device of a caller, who may be the speaker. Other participants may also participate in the media session and, when such participants speak, their identity may also be determined according to the techniques described herein. Additionally or alternatively, the media may be provided by a server device (e.g., when music, recording, television shows, clips, movies, and/or other such media may be provided).

Based on the identity of the media and/or the speaker, the system may determine if there is a tuning profile for the media and/or speaker associated with the listener (e.g., created or stored within the storage block associated with the listener). If there is a tuning profile stored, the tuning profile may be accessed and loaded. In various embodiments, the tuning profiles may be configured to modify audio data to allow for the listener to better understand and/or appreciate the auditory quality of the media. The tuning profiles may modify various DSP parameters, including any such parameters described herein.

In 1312, the first profile and/or the speaker profile may be applied to the audio data containing the sound of the media (e.g., to allow for the listener to better understand the media and/or the speaker). In embodiments that apply both the first profile and the tuning profile to the audio, both profiles may be configured to modify DSP parameters of the DSP that outputs audio with the electronic device of the first user. The profiles may be applied sequentially (e.g., the first profile may first be applied and the tuning profile may be applied to the DSP parameters that have been modified by the first profile) or may be combined into a single profile that may then be applied to the DSP parameters or the tuning profile may be applied instead of the first profile. In embodiments that apply a combined single profile, the combining of the profiles may be via additive, subtractive, multiplicative, divisional, or other combinations of the parameters of the profile (e.g., additive, subtractive, multiplicative, and/or divisional operations of the modification parameters, which may be numerical magnitudes).

The profile(s) and/or audio modified by the profile(s) may be transmitted to the electronic device of the listener and the electronic device may then output audio modified according to the profile(s) in 1314. Such output may be via, for example, a speaker (e.g., loudspeaker, headphone, earbud, or other output device) of the electronic device.

FIG. 14 illustrates a variation of the technique in FIG. 13. In FIG. 14, the identity of the listener is determined in 1404 and the first profile is accessed in 1406 in a first communication session between the electronic device of the listener and the personalization node. The first profile may be used to modify audio data output by the electronic device (either through application by the audio personalization engine and/or through application by the electronic device to audio data). The first profile may, thus, serve as the baseline profile for modifying sounds output to the listener.

In 1408, a second electronic device may communicate with the electronic device. The second electronic device may provide audio data to the electronic device for output to the listener. The audio data may include any audio data as described herein, including data related to a conversation and/or data related to various media.

The identity of the media may be determined in 1408, according to the techniques described herein. Based on the identity of the media, a tuning profile associated with the media and the listener may be provided and/or accessed in 1410. The tuning profile may be applied in 1412. It is appreciated that, while the embodiment of 1312 may apply both the first profile and the tuning profile, the embodiment of 1412 utilizes the tuning profile as a replacement for the first profile. That is, the electronic device of the listener and/or the personalization node may utilize the tuning profile in place of the first profile. In various embodiments, the tuning profile may include enhancements utilized by the first profile, but with additional enhancements and/or tuning for the media. The tuned audio is then output in 1414.

### Computing System Example

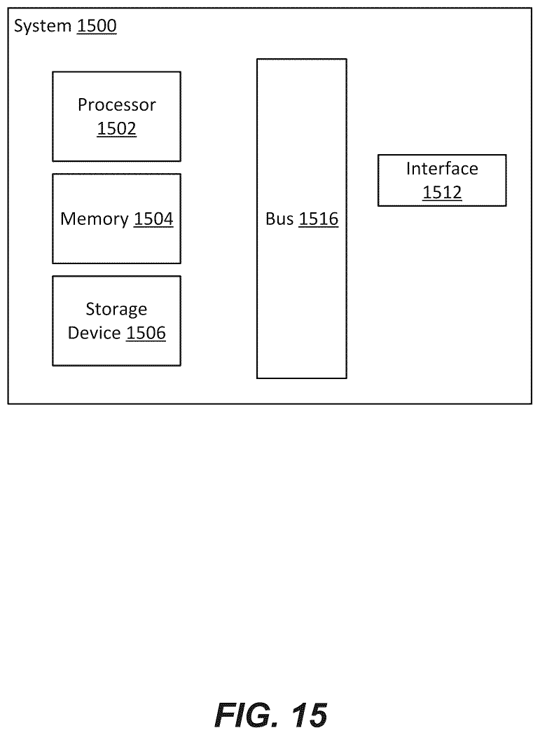

FIG. 15 illustrates a block diagram of an example computing system, in accordance with some embodiments. According to various embodiments, a system 1500 suitable for implementing embodiments described herein includes a processor 1502, a memory module 1504, a storage device 1506, an interface 1512, and a bus 1516 (e.g., a PCI bus or other interconnection fabric.) System 1500 may operate as variety of devices such as a server system such as an application server and a database server, a user device such as a laptop, desktop, smartphone, tablet, wearable device, set top box, etc., or any other device or service described herein.

Although a particular configuration is described, a variety of alternative configurations are possible. The processor 1502 may perform operations such as those described herein. Instructions for performing such operations may be embodied in the memory 1504, on one or more non-transitory computer readable media, or on some other storage device. Various specially configured devices can also be used in place of or in addition to the processor 1502. The interface 1512 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

While various embodiments have been described herein, it should be understood that they have been presented by way of example only, and not limitation. For example, some techniques and mechanisms are described herein in the context of fulfillment. However, the disclosed techniques apply to a wide variety of circumstances. Particular embodiments may be implemented without some or all of the specific details described herein. In other instances, well known process operations have not been described in detail in order not to unnecessarily obscure the techniques disclosed herein. Accordingly, the breadth and scope of the present application should not be limited by any of the embodiments described herein, but should be defined only in accordance with the claims and their equivalents.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A system comprising:
a personalization node, comprising a personalization database and configured to establish a media session between a plurality of electronic devices, the personalization node configured to perform operations comprising:
establishing a first communication session between a first electronic device;
determining that the first electronic device is associated with a first user;
accessing, from the personalization database and based on determining that the first electronic device is associated with the first user, a first profile associated with the first user;
establishing a first media session between at least a first electronic device and a second electronic device;
determining characteristics of the media provided by the second electronic device;
accessing, from the personalization database and based on the characteristics of the media provided by the second electronic device, a tuning profile pertaining to the characteristics of the media;
modifying first audio data provided by the second electronic device with the tuning profile pertaining to the characteristics of the media; and
outputting the modified first audio data via the first electronic device.

2. The system of claim 1, wherein the first profile and the tuning profile are stored within the personalization database in a storage block associated with the first user.

3. The system of claim 1, wherein the media provided by the second electronic device is speech of a second user, and wherein the characteristics of the media is an identity of the second user.

4. The system of claim 3, wherein the first media session further includes a third electronic device, wherein the determination that the second user is speaking through the second electronic device is at a first time, and wherein operations further comprise:
determining, at a second time that a third user is speaking through the third electronic device;
accessing, from the personalization database and based on determining that the third user is speaking, a tuning profile pertaining to speech of the third user and associated with the first user;
modifying second audio data of the third user speaking with the first profile and the tuning profile pertaining to speech of the third user; and
outputting the modified second audio data through the first electronic device.

5. The system of claim 3, wherein the identity of the second user is determined by correlating identifying information provided by the second electronic device to the second user and/or by determining vocal characteristics of the speaker and correlating the vocal characteristics to the second user.

6. The system of claim 3, wherein the determination that the second user is speaking through the second electronic device is at a first time, and wherein the operations further comprise:
determining, at a second time that a third user is speaking through the second electronic device;
accessing, from the personalization database and based on determining that the third user is speaking, a tuning profile pertaining to speech of the third user and associated with the first user;
modifying second audio data of the third user speaking with the first profile and the tuning profile pertaining to speech of the third user; and
outputting the modified second audio data through the first electronic device.

7. The system of claim 1, wherein the characteristics of the media determined is a genre, title, and/or speaker of the media.

8. The system of claim 1, wherein the operations further comprise:
establishing a tuning media session between at least the first electronic device and the second electronic device;
determining that the media is provided during the tuning media session;
outputting tuning audio data of the media through the first electronic device;
receiving, from the first electronic device, tuning inputs to the tuning audio data; and
storing, within the personalization database, the tuning profile pertaining to the media and associated with the first user, wherein the tuning profile is tuned by the tuning inputs.

9. The system of claim 8, wherein the tuning profile pertaining to the media and associated with the first user is accessed through a tuning profile lookup within the personalization database.

10. The system of claim 1, wherein the tuning profile pertaining to the media and associated with the first user is selected from a plurality of tuning profiles associated with the media and the first user.

11. A method comprising:
establishing a first media session between at least a first electronic device and a second electronic device;
determining that the first electronic device is associated with a first user;
accessing, from a personalization database and based on determining that the first electronic device is associated with the first user, a first profile associated with the first user;
determining characteristics of the media provided by the second electronic device;
accessing, from the personalization database and based on the characteristics of the media provided by the second electronic device, a tuning profile pertaining to the characteristics of the media;
modifying first audio data provided by the second electronic device with the first profile and the tuning profile pertaining to the characteristics of the media; and
outputting the modified first audio data through the first electronic device.

12. The method of claim 11, wherein the first profile and the tuning profile are stored within the personalization database in a storage block associated with the first user.

13. The method of claim 11, wherein the media provided by the second electronic device is speech of a second user, and wherein the characteristics of the media is an identity of the second user.

14. The method of claim 13, wherein the first media session further includes a third electronic device, wherein the determination that the second user is speaking through the second electronic device is at a first time, and wherein the method further comprises:
determining, at a second time that a third user is speaking through the third electronic device;
accessing, from the personalization database and based on determining that the third user is speaking, a tuning profile pertaining to speech of the third user and associated with the first user;
modifying second audio data of the third user speaking with the first profile and the tuning profile pertaining to speech of the third user; and
outputting the modified second audio data through the first electronic device.

15. The method of claim 13, wherein the identity of the second user is determined by correlating identifying information provided by the second electronic device to the second user and/or by determining vocal characteristics of the speaker and correlating the vocal characteristics to the second user.

16. The method of claim 13, wherein the determination that the second user is speaking through the second electronic device is at a first time, and wherein the method further comprises:
determining, at a second time that a third user is speaking through the second electronic device;
accessing, from the personalization database and based on determining that the third user is speaking, a tuning profile pertaining to speech of the third user and associated with the first user;
modifying second audio data of the third user speaking with the first profile and the tuning profile pertaining to speech of the third user; and
outputting the modified second audio data through the first electronic device.

17. The method of claim 11, wherein the characteristics of the media determined is a genre, title, and/or speaker of the media.

18. The method of claim 11, further comprising:
establishing a tuning media session between at least the first electronic device and the second electronic device;
determining that the media is provided during the tuning media session;
outputting tuning audio data of the media through the first electronic device;
receiving, from the first electronic device, tuning inputs to the tuning audio data; and
storing, within the personalization database, the tuning profile pertaining to the media and associated with the first user, wherein the tuning profile is tuned by the tuning inputs.

19. The method of claim 18, wherein the tuning profile pertaining to the media and associated with the first user is accessed through a tuning profile lookup within the personalization database.

20. The method of claim 11, wherein the tuning profile pertaining to the media and associated with the first user is selected from a plurality of tuning profiles associated with the media and the first user.
